(19) United States
(12) Patent Application Publication
(10) Pub. No.: US 2006/0178978 A1
(43) Pub. Date: Aug. 10, 2006

(54) System and method for soliciting a bid to list a property

(76) Inventors: Brian A. McLain, Webster Groves, MO (US); Vincent J. Rizzo, Wildwood, MO (US); Susan M. Rizzo, Wildwood, MO (US); James G. Onder, St. Louis, MO (US); James E. Truesdale, Glendale, MO (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/054,070

(22) Filed: Feb. 8, 2005

(51) Int. Cl. G06Q 40/00

(52) U.S. Cl. 705/37

(57) ABSTRACT

A method in a data processing system is provided for soliciting bids to list a property for sale. The method includes receiving from a seller a request to list a property for sell, receiving information for listing the property, providing the listing information to one or more brokers, receiving one or more bids to list the property from the one or more brokers based on the listing information, and providing the one or more bids to the seller.

### BACKGROUND OF THE INVENTION

The present invention relates to a bidding system, and, more particularly, to systems and methods for soliciting bids from real estate agents or brokers based upon their commission fees.

Selling property through a broker is typically a time consuming process for the seller seeking to minimize the cost of a broker to handle the sale. Typically, the seller must manually seek out brokerage firms or independent brokers (via phone, e-mail, personal visits, etc.) to obtain a commission estimate for listing the property to be sold and to negotiate the terms for the services to be provided by the broker, including number of days to list the property (“listing days”), advertising, open houses, finance check of potential buyers. This process is particularly arduous for a seller who is not accustomed to negotiating or who does not have the time to contact respective brokers.

In addition, sellers often are not aware that brokers typically do not charge the same commission rates or ask for the same number of listing days. Like any other business, brokers may have a slow period and therefore be willing to reduce their commission rates. But brokers willing to reduce their commission rate will likely only do so anonymously so that they can privately lower their prices only for a period of time, in a certain area, or for a particular listing. A broker is not likely to publicly advertise a reduced commission rate for fear of spurring a price war among brokers in a given area or inhibiting the broker from later charging a higher rate to another seller within the same area. Thus, a seller who does not manually seek out brokers to negotiate a reduced rate typically agrees to pay a current market commission rate, such as 6% or 7%, for a broker to list the property.

Therefore, a need has long existed for a method and system that overcome the problems noted above and others previously experienced.

### SUMMARY OF THE INVENTION

In accordance with methods consistent with the present invention, a method in a data processing system for soliciting a bid to list a property is provided. The method comprises: receiving from a seller a request to list a property for sale; receiving information for listing the property; providing the listing information to one or more brokers, receiving one or more bids to list the property from each of the one or more brokers based on the listing information, and providing the one or more bids to the seller.

In accordance with systems consistent with the present invention, a data processing system is provided. The data processing system comprises a seller computer operatively connected to a network and a plurality of broker computers each operatively connected to the network. The data processing system further comprises means for receiving, via the seller computer, a request to list a property for sale, means for receiving via the seller computer information for listing the property, means for providing the listing information to a plurality of brokers each operating on a respective one of the broker computers, means for receiving one or more bids to list the property from each of the plurality of brokers based on the listing information, and means for providing the one or more bids to the seller computer.

In accordance with systems consistent with the present invention, a data processing system is provided that includes a seller computer operatively connected to a network and a plurality of broker computers operatively connected to the network. The data processing system further includes a memory having a bid server program operatively connected, via the network, to the seller computer and to the broker computers. The bid server program receives from a seller operating on the seller computer a request to list a property, receives information for listing the property, provides the listing information to a plurality of brokers operating on the broker computers, receives one or more bids to list the property from each of the one or more brokers based on the listing information, and provides the one or more bids to the seller. The data processing system also includes a processor to run the bid server program.

In accordance with articles of manufacture consistent with the present invention, a computer-readable medium containing instructions causing a bid server program in a data processing system to perform a method is provided. The method comprises: receiving from a seller a request to list a property for sale; receiving information for listing the property; providing the listing information to one or more brokers; receiving one or more bids to list the property from each of the one or more brokers based on the listing information; and providing the one or more bids to the seller.

Other systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 depicts a block diagram of a system having a real estate bid server suitable for practicing methods and implementing systems consistent with the present invention;

FIGS. 2A-2B depict a flow diagram of an exemplary process performed by the bid server to allow a broker to register to bid to list an available property;

FIG. 3 depicts an exemplary user interface accessed via the bid server for display on a broker computer in the data processing system in response to a request by a broker to register;

FIGS. 4A-4C depict a flow diagram of an exemplary process performed by the bid server to solicit bids to list a property consistent with the present invention;

FIG. 5 depicts an exemplary user interface accessed via the bid server for display on a seller computer in the data processing system in response to a request by the seller to solicit bids for listing a property;

FIG. 6 depicts an exemplary user interface accessed via the bid server for display on a broker computer in the data processing system that allows the broker to view one or more available properties to bid to list for sell;

FIG. 7 depicts another exemplary user interface accessed via the bid server for display on a broker computer in the data processing system that allows the broker to view profile information for a selected one of the available properties to bid to list for sell;

FIG. 8 depicts another exemplary user interface accessed via the bid server for display on a broker computer in the data processing system that allows the broker to submit a bid to list the selected one of the available properties;

FIG. 9 depicts another exemplary user interface accessed via the bid server for display on a seller computer in the data processing system that allows the seller to view bids for listing the property;

FIG. 10 depicts another exemplary user interface accessed via the bid server for display on a broker computer in the data processing system that allows the broker to view the status of the submitted bid; and

FIG. 11 depicts another exemplary user interface accessed via the bid server for display on a seller computer in the data processing system that allows the seller to view profile information for the broker before selecting the broker's bid.

### DETAILED DESCRIPTION OF THE INVENTION

Reference will now be made in detail to an implementation in accordance with methods, systems, and products consistent with the present invention as illustrated in the accompanying drawings. The same reference numbers may be used throughout the drawings and the following description to refer to the same or like parts.

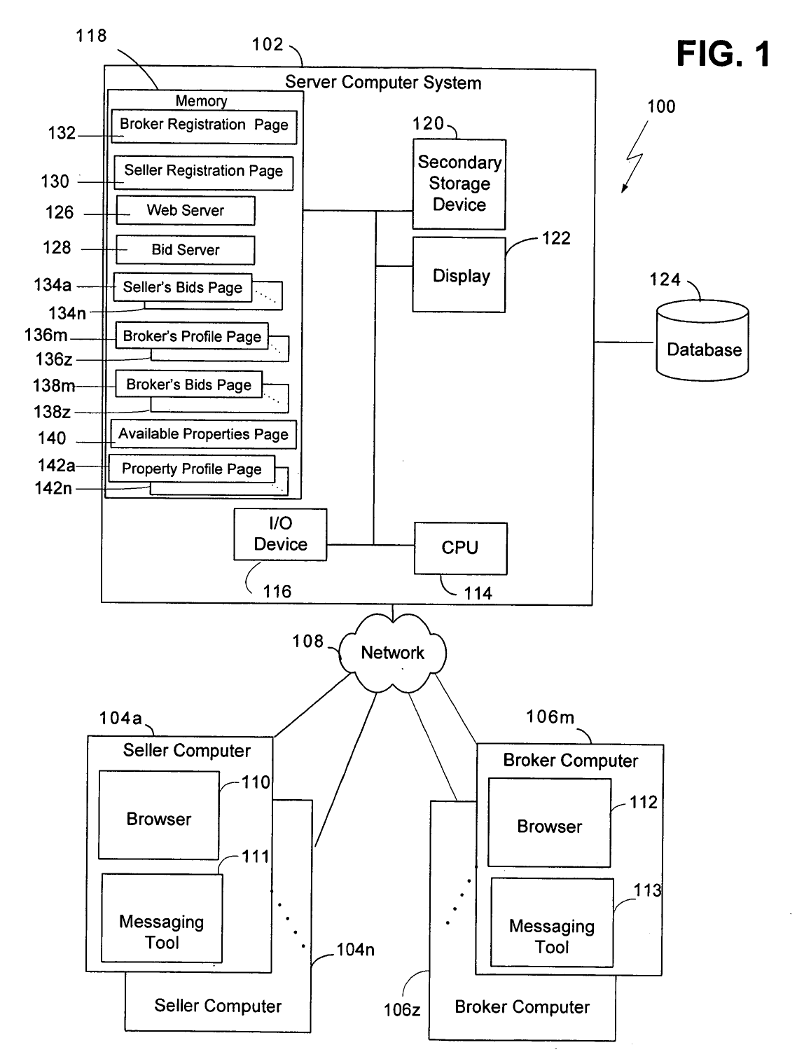

FIG. 1 depicts a block diagram of a data processing system 100 suitable for use with methods and systems consistent with the present invention. The data processing system 100 includes a server computer system 102, one or more seller computers 104a-104n, and one or more broker computers 106m-106z. The server computer system 102 is operatively connected to each seller computer 104a-104n and to each broker computer 106m-106z across a network 108. Each seller computer 104a-104n and each broker computer 106m-106z may be any general-purpose computer system such as an IBM compatible, Apple, or other equivalent computer. The network 108 may be any known private or public communication network, such as a local area network (“LAN”), WAN, Peer-to-Peer, or the Internet, using standard communications protocols. The network 108 may include hardwired as well as wireless branches.

Each seller computer 104a-104n and each broker computer 106m-106z includes a respective browser (e.g., browser 110 and 112), such as Microsoft™ Internet Explorer or Netscape Navigator™, capable of accessing a web page across the network 108. Each seller computer 104a-104n and each broker computer 106m-106z may also include a respective messaging tool (e.g., messaging tool 111 and 113), which may be any known e-mail tool or instant messaging tool capable of receiving a message across the network 108. As explained in detail below, the server computer system 102 is operatively configured to allow a seller using a respective seller computer 104a-104n to solicit a bid to list a property from one or more brokers on computers 106m-106n across the network 108.

The server computer system 100 includes a central processing unit (CPU) 114, an input output I/O device 116 (e.g., for a network connection), a memory 118, and a secondary storage device 120. The server computer system 100 may further include a display 122. The output I/O device 116 may include user input devices, such as a keyboard or a mouse (not shown in figures). The server computer system 100 may also include a database 124 to store seller information, broker information, and listing bids of a property identified by a seller obtained using methods discussed below.

The memory 106 stores a web server 126, such as Tomcat 4.1 available from the Apache Software Foundation, and a bid server 128, both of which are called up by the CPU 114 from memory 118 as directed by the CPU 114. The CPU 114 operatively connects the web server 126, the bid server 128, and other computer programs to one another (e.g., using a standard operating system program not shown in the figures) to perform operations as described herein below.

The memory 106 may also include a seller registration page 130 and a broker registration page 132. In accordance with methods and systems consistent with the present invention, the bid server 128 is operatively configured to allow a seller on a seller computer 104a-104n to access the seller registration page 130 to register a property with the bid server 128 and to allow a broker on a broker computer 106m-106z to access the broker registration page 132 to register to make a bid on a property identified by the bid server 128.

The bid server 128 is also operatively configured to allow the seller that has registered a property with the bid server 128 to access a respective bids page 134a-134n associated with the seller to view any bids for listing the property. As described in detail below, each seller's bids page 134a-134n may include a selectable link associated with each bid by the bid server 128 to allow the seller to select and view a profile page (e.g., one of 136k-136n) of the broker that submitted the bid. Each seller's bid page 134a-134n and each broker's profile page may be stored in memory 106. However, respective seller's property listing information and bids on the property may be stored by the bid server 128 in the database 124 in accordance with a property number assigned by the bid server 128 based on the respective seller. The bid server 128 is able to recognize the last property number assigned to property of a seller such that the listing bid 128 is able to assign a next property number when the seller requests that bids be solicited on another property. By assigning a property number to the listing information provided by a seller, the bid server 128 is able to allow a broker to access the property listing information and bid to list the property while the seller and the broker each remain anonymous to each other.

The bid server 128 is further operatively configured to allow the broker that has registered to access a respective broker's bids page 138m-134z to view the status of any bids submitted by the broker or to access an available properties page 140, which may be controlled by the bid server 128 to display properties available for a listing bid in an area associated with broker viewing the properties page 140. As described in detail below, the properties page 140 may include a link associated with a respective property by the bid server 128 to allow a broker to view a profile 142a-142n associated with the property that identifies listing information about the property. The listing information may include a zip code of the property, a type of property (e.g., residence, condo/cluster coop, multi-family, residential lot, or farm/acreage), an asking price or price range for the property, a date on which bidding is to end (from current date), a date on which property to is be placed on the market, and a duration of listing. The property profile 142a-142n may also include requested services wanted by the seller of the property, such as identifying the property with a known real estate multiple listing service (MLS) so other brokers or real estate firms may be aware to the property listing. As discussed below, the properties available page 140 or the respective property profile pages 142a-142n may include a link to a web page 144 generated by the bid server 128 to allow a broker to make a bid on a corresponding property. Each broker's bids page 138m-138z, the available properties page 140, each property profile 142a-142n, and the make bid page 144 may be stored in memory 106 or in other storage, such as secondary storage device 120.

Each seller's bids page 134a-134n, each broker's profile page 136m-136z, each broker's bids page 138m-138z, the available properties page 140, each property profile page 142a-142n, and the make bid page 144 may comprise a respective user interface for the bid server 128 as discussed below and may be implemented as Java applets executed by the browser 110 or 112 on the respective seller computer 104a-104n or respective broker computer 106m-106z. However, other programming languages and user-interface approaches may also be used to facilitate data entry and execute the various computer programs that make up the present invention.

The bid server 128 may comprise or may be included in one or more code sections containing instructions for performing respective operations. The bid server 128 may be implemented as a Java servlet. However, other programming languages and user-interface approaches may also be used to implement the bid server 128 in accordance with the present invention. While the bid server 128 and other programs and web pages are described as being implemented as software, the present implementation may be implemented as a combination of hardware and software or hardware alone. In addition, although aspects of one implementation shown in FIG. 1 are depicted as being stored in memory, one skilled in the art will appreciate that all or part of systems and methods consistent with the present invention may be stored on or read from other computer-readable media, such as secondary storage devices, like hard disks, floppy disks, and CD-ROM; a carrier wave received from a network such as the Internet; or other forms of ROM or RAM either currently known or later developed. Further, although specific components of data processing system 100 have been described, one skilled in the art will appreciate that a data processing system suitable for use with methods, systems, and articles of manufacture consistent with the present invention may contain additional or different components.

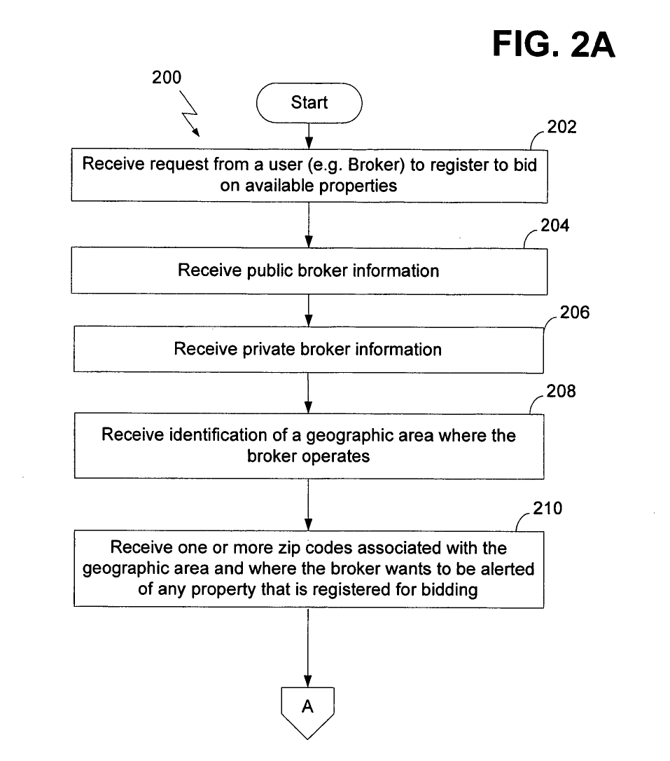

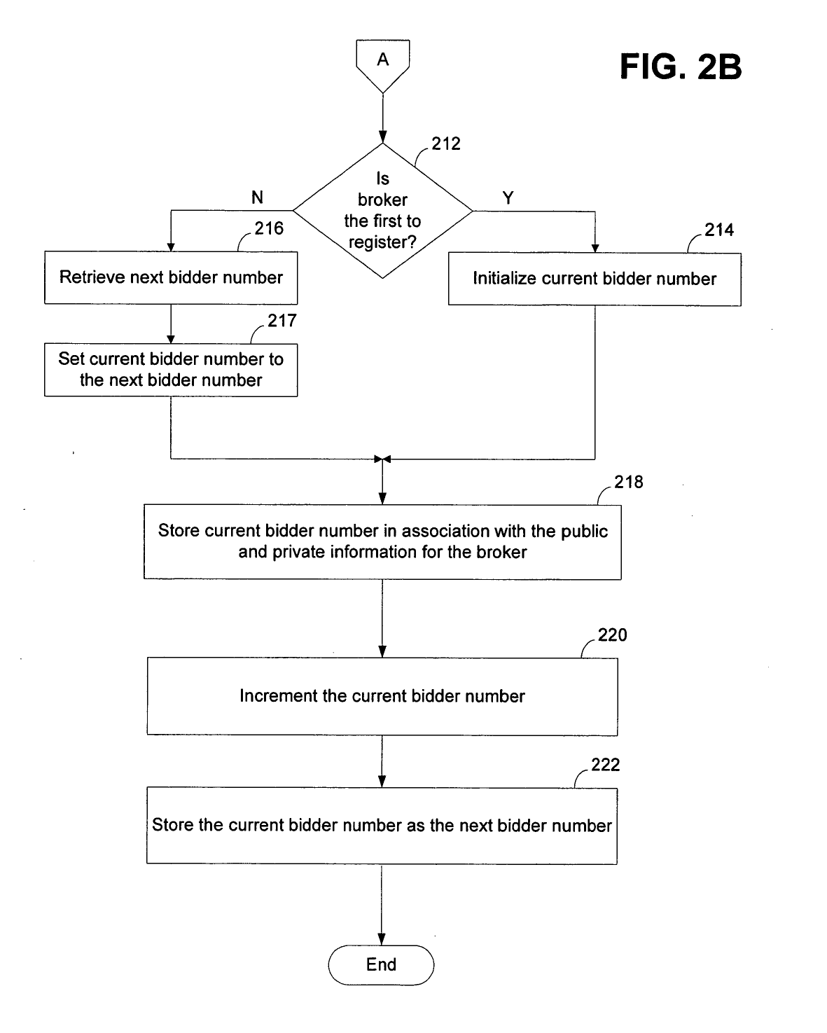

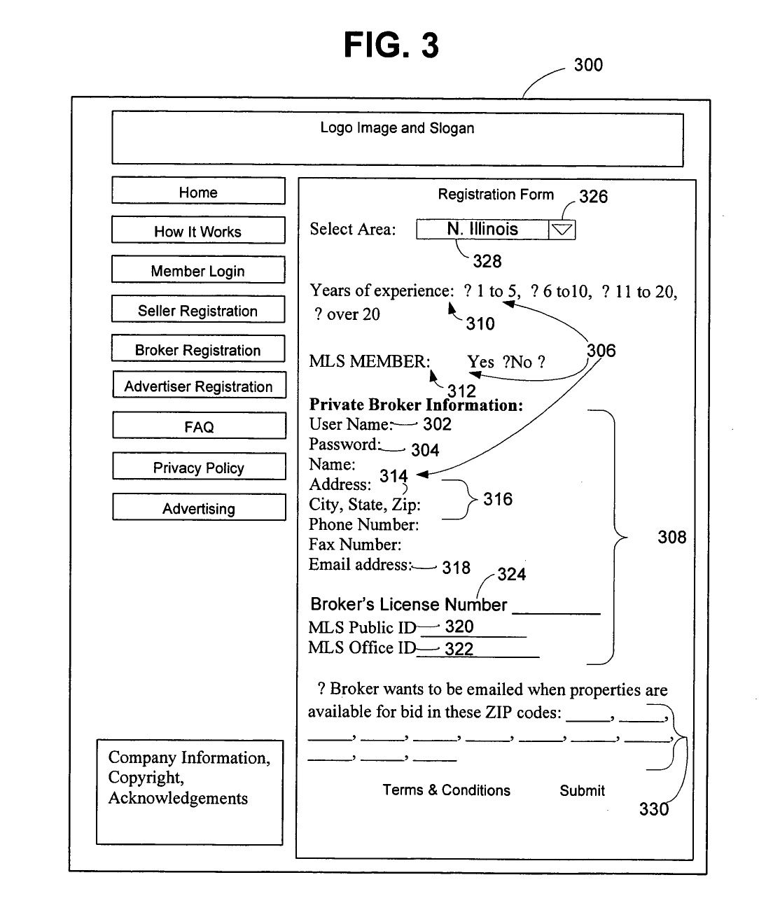

FIGS. 2A-2B depict a flow diagram of an exemplary process performed by the bid server to allow a broker to register to bid to list an available property. Initially, the bid server 128 receives a request from a user (e.g., a broker) to register (Step 202). In one implementation, the broker may submit the request to register by using the browser 112 of the broker computer 106m-106z to access the broker registration page 132 or to access a homepage that has a link to the broker registration page 132 (not shown in the figures). Access to the broker registration page 132 is controlled by the bid server 128 via the web server 126. In this implementation, the seller may enter the uniform resource locator (URL) or network address of the bid server 128 to prompt the bid server 128 to provide access to the broker registration page 132. FIG. 3 depicts an exemplary user interface 300 corresponding to the broker registration page 132 displayed on a broker computer (e.g., broker computer 106m) in response to the broker's request to register to bid to list an available property. Before granting access to the broker registration page 132, the bid server 128 may first require the person seeking access to provide a user name 302 in FIG. 3 and a password 304 so that the bid server 128 is able to identify the user as a member broker (i.e., a previously registered broker).

The bid server 128 then receives public broker information (Step 204) and private broker information (Step 206). In the implementation shown in FIG. 3, the broker may submit public broker information 306 and private broker information 308 to the bid server 128, via user interface 300 on the buyer computer 106m. The public broker information 306 may include years of experience 310, an indication of MLS membership 312, and a zip code of the broker's office 314. The bid server 128 incorporates the public broker information 306 into the respective broker profile page 136m-136z for access by a seller seeking information about the broker when the broker submits a bid to the seller as discussed below. The private broker information 308 may include the user name 302, the password 304, an office address of the broker 316 that includes the broker's office zip code 314, and an e-mail address 318 for communicating with the broker, via a messaging tool 113. The private broker information 318 may further include an MLS public identification 320 and an MLS office identification 320 or a broker's license number 324 if the broker is not an MLS member. The bid server 128 may use the private broker information 318 to verify, via on-line MLS directory databases or real estate agent databases, whether the broker is an MLS member or licensed real estate agent before allowing the broker to submit a bid to list a property.

Next, the bid server 128 receives identification regarding a geographic area where the broker operates (Step 208). The bid server 128 may also receive one or more zip codes for bidding that are associated with the area and where the broker wants to be alerted of any property registered for bidding (Step 210). In the implementation shown in FIG. 3, the broker may “mouse click” on a drop down menu bar 326 to identify a geographic area 328 (e.g., “N. Illinois”) in which the broker operates or lists properties for sale. In addition, the broker may input, via keyboard entry on the user interface 300, the one or more zip codes 330 associated with the area 328 in which the broker operates. As discussed below, the bid server 128 is operatively configured to provide a property profile page 142a-142n to a broker based on listing information for the property. In one implementation, the bid server 128 provides the property profile page 142a to the broker when the zip code of the property is determined by the bid server 128 to be within the geographic area 328 identified by the broker. In another implementation, the bid server 128 provides the property profile page 142a to the broker when the zip code of the property is determined by the bid server 128 to be within the one or more zip codes 328 associated with the area. Thus, the bid server 128 allows the broker to be more selective with respect to properties that are identified by the bid server 128 to the broker for bidding.

Next, the bid server 128 determines whether the broker is the first broker to register (Step 212). If the broker is the first broker to register, the bid server 128 initializes a current bidder number (Step 214) and continues processing at Step 218. If the broker is not the first broker to register, the bid server 128 retrieves a next bidder number (Step 216), which may be stored and maintained by the bid server 128 in the database 124. The bid server 128 sets the current bidder number to be the next bidder number (Step 217) and continues processing at Step 218.

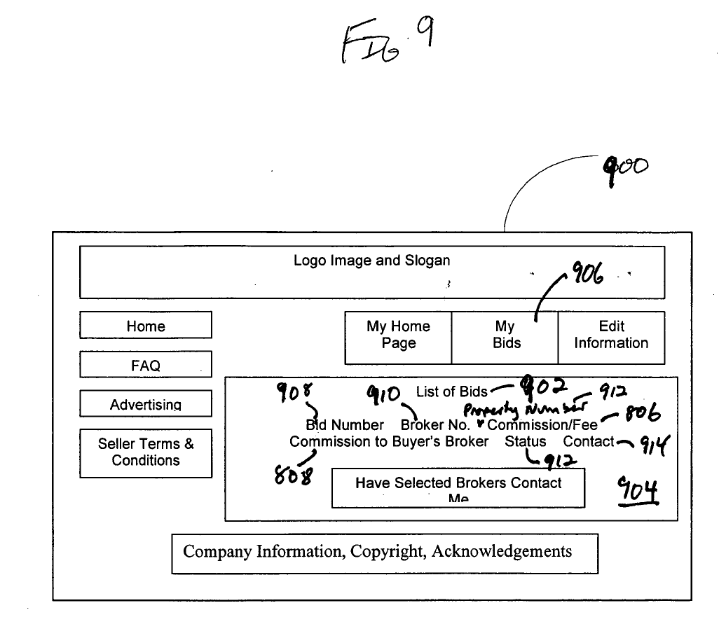

The bid server 128 then stores the current bidder number in association with the public broker information and the private broker information (Step 218), such that the current bidder number (e.g., bidder number 910 in FIG. 9) represents the broker and may be used by the bid server 128 to refer to the broker when providing a bid from the broker to the seller. Thus, the bid server 128 allows the broker to remain anonymous when providing a bid to the seller.

Next, the bid server 128 increments the bidder number (Step 220) and stores the bidder number as the next bidder number (Step 222) before ending processing for registering the broker.

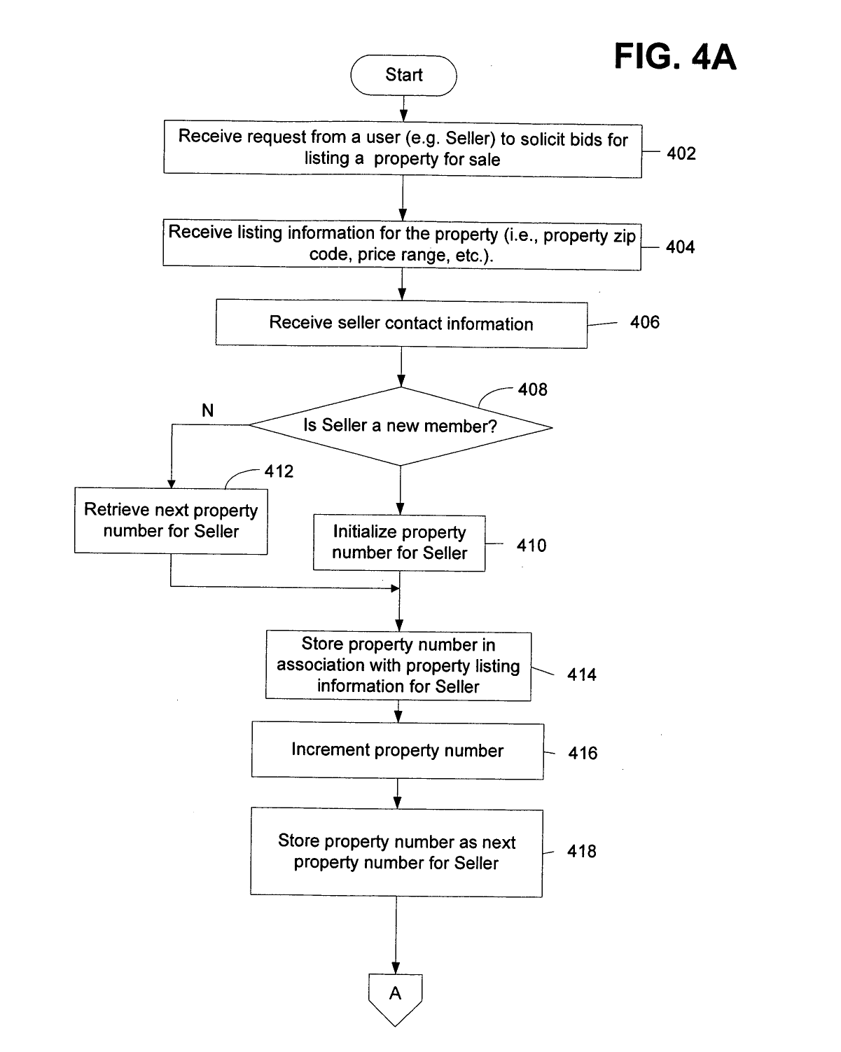

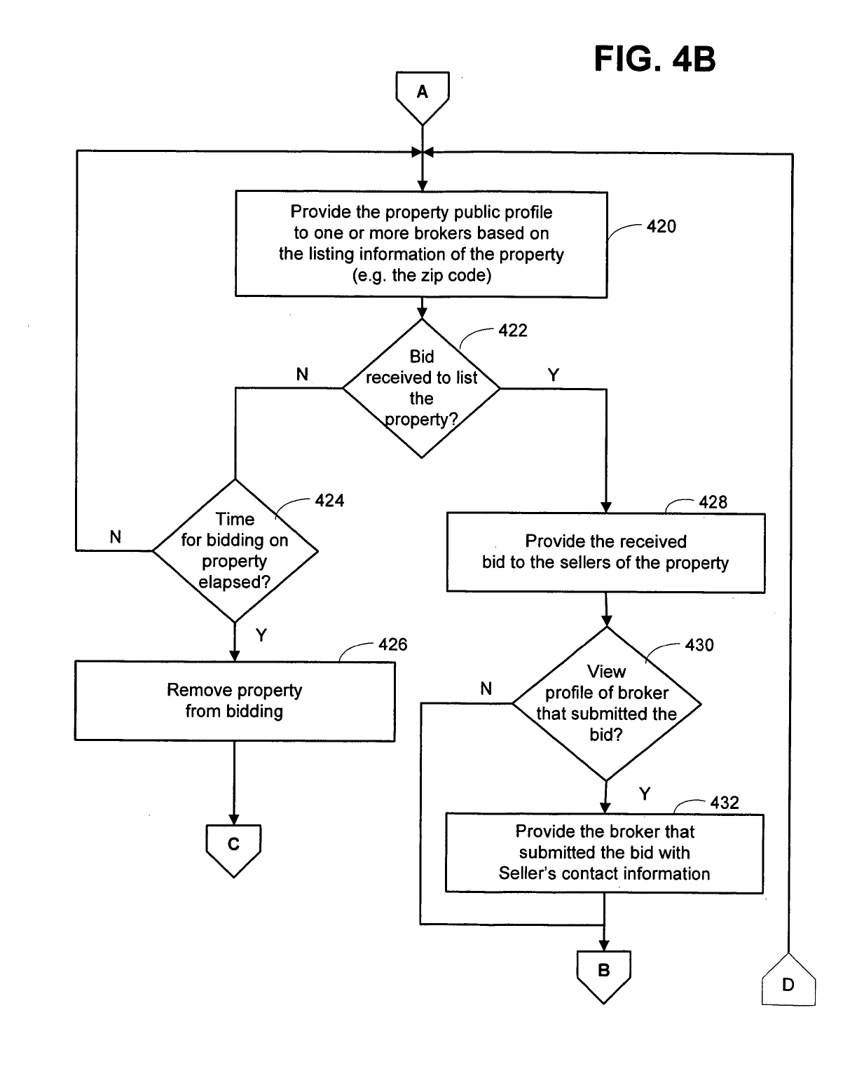

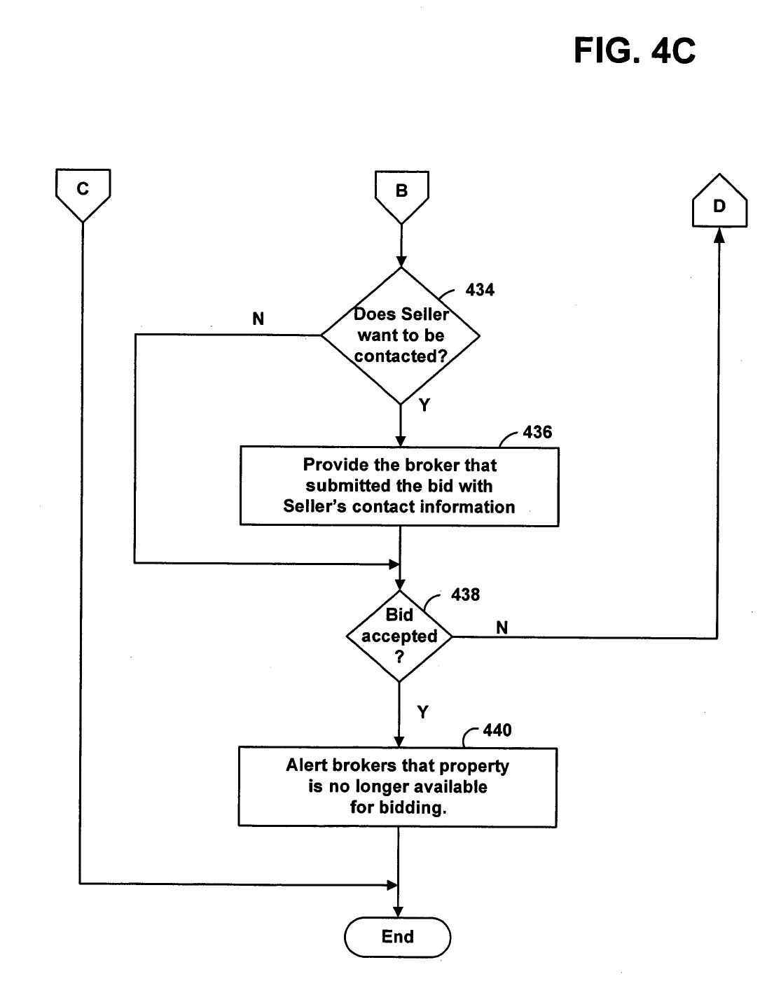

FIGS. 4A-4C depict a flow diagram of an exemplary process 400 performed by the bid server 128, in response to a seller's request to solicit bids to list a property from one or more brokers. In performing the process 400, the bid server 128 allows one or more brokers (e.g., member brokers) to bid to list the property anonymously and allows the seller to receive the bids to list the property while also remaining anonymous to the one or more brokers. Thus, the bid server 128 allows brokers to bid on listing the property (and provide lower commission rates) to promote competition in the market when the brokers may not have otherwise publicly acquiesced to lower their commission rates. Although not depicted, as would be understood by one skilled in the art, the bid server 128 is able to perform the processes 200 and 400 in parallel (e.g., as separate threads of a combined process).

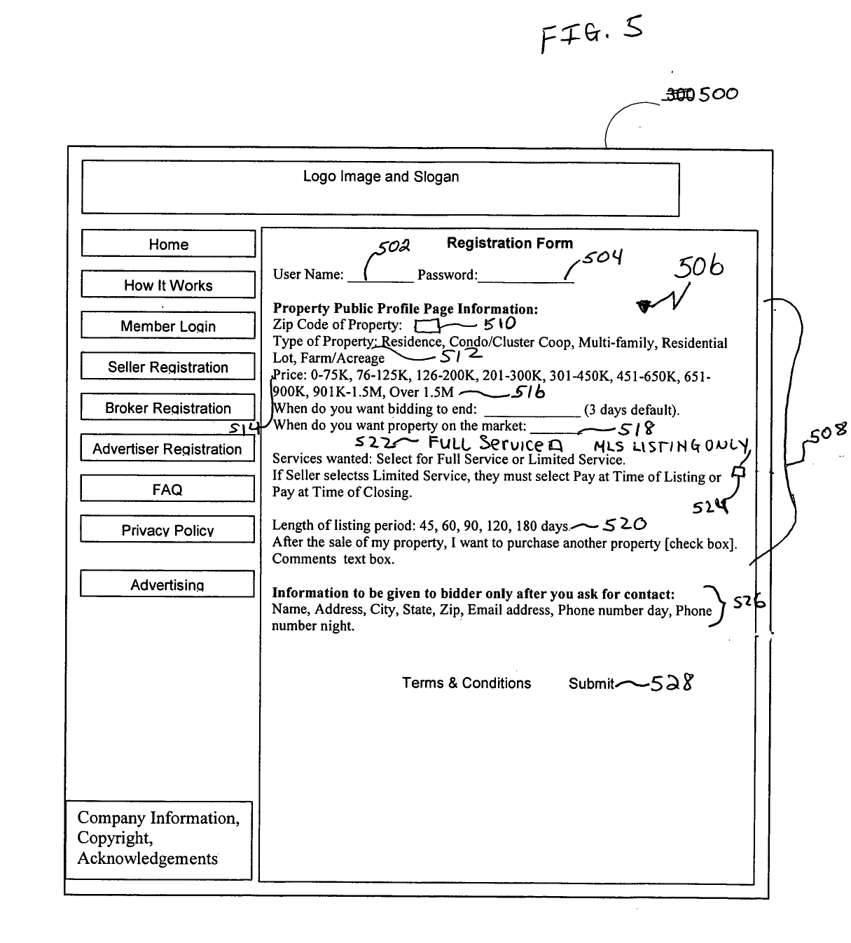

Turning to FIG. 4A, the bid server 128 initially receives a request from a user (e.g., a seller) to solicit bids for listing a property for sale (Step 402). In one implementation, the seller may submit the request to solicit bids by using the browser 110 of the seller computer 104a-104n to access the seller registration page 130 or to access a homepage having a link to the seller registration page 130 (not shown in the figures), which is controlled by the bid server 128 via the web server 126. In this implementation, the seller may enter the uniform resource locator (URL) or network address of the bid server 128 to prompt the bid server 128 to provide access to the seller registration page 130. FIG. 5 depicts an exemplary user interface 500 corresponding to the seller registration page 130 displayed on a seller computer (e.g. seller computer 104a) in response to the seller seeking access to the registration page to request to solicit bids for listing a property. Before granting access to the seller registration page 130, the bid server 128 may first require the person seeking access to provide a user name 502 in FIG. 5 and a password 504 so the bid server 128 is able to identify the user as a member seller (i.e., a previously registered seller).

Next, the bid server 128 receives listing information for the property (Step 404). As shown in FIG. 5, the seller may submit, via user interface 500 on the seller computer 104a, listing information 506 that includes property public profile information 508, which may be incorporated by the bid server 128 into a respective property profile page 142a-142n for a broker to view when accessing the bid server 128 for available properties to bid on listing for sale. The property public profile information 508 may include a zip code of the property 510, a type of property 512 (e.g., residence, condo/cluster coop, multi-family, residential lot, or farm/acreage), a price 514 or price range for the property, a date on which bidding is to end 516, a date on which property is to be placed on the market 518, and a duration of the listing 520. The property public profile information 508 may also include a selection of either full service 522 or limited service 524, such as only identifying the property in an MLS listing.

The bid server 128 then receives seller contact information (Step 406). As shown in FIG. 5, the seller may provide contact information 526 to the bid server 128 via user interface 500 corresponding to registration the page 130. The seller contact information 526 may include a name 528, address 530, city 532, state 534, zip code 536, e-mail address 538, and phone number 540 of the seller. The bid server 128 will provide the seller contact information 510 to a broker that has submitted a bid to the seller, when the seller requests to have the broker contact the seller as further described below. The seller may submit the listing information 508 and seller contact information 526 by actuating the submit button 528 on the user interface 500.

The bid server 128 then determines whether the seller is a new member (Step 408). If the seller is a new member, the bid server 128 initializes a property number for the seller (Step 410) and continues processing at Step 414. If the seller is not a new member, the bid server 128 retrieves a next property number for the seller (Step 412), which was previously stored for the seller by the bid server 128 in the database 124. The bid server 128 is able to recognize that the next property number is unassigned and sets the next property number as the current property number.

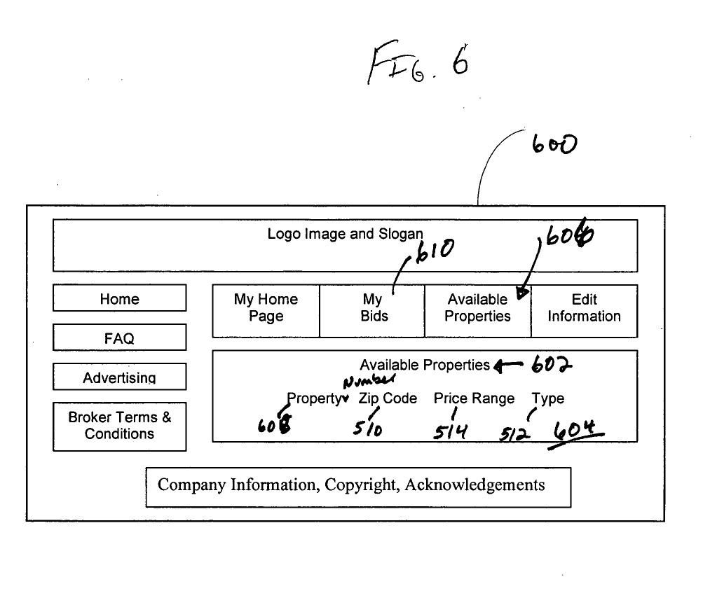

Next, the bid server 128 stores the current property number (e.g., property number 608 in FIG. 6) in association with the property listing information (Step 414) so the bid server is able to associate any received bids with the respective property for the seller. In this implementation, one property is associated with a respective property number for a respective seller. In one implementation, the bid server 128 also stores the seller contact information in association with the current property number so the seller may identify different contact information for another property registered with the bid server 128.

The bid server 128 then increments the current property number (Step 416) and stores the current property number as the next property number for the seller (Step 418) so the bid server 128 is able to identify the next property number that may be assigned to represent a next property registered by a respective seller for bids to list for sale.

Next, the bid server 128 provides the property public profile to one or more brokers based on the listing information of the property (Step 420). In one implementation, the bid server 128 provides the property public profile information 508 to the one or more brokers by incorporating the property public information 508 into a respective property profile page 142a-142n for a broker to access from the broker computer 106m-106z. For example, FIG. 6 depicts an exemplary user interface 600 corresponding to available properties page 140 provided by the bid server 128 to the respective broker computer 106m-z being used by the broker after logging in or registering with the bid server 128. In this implementation, the broker may cause the bid server 128 to provide the one or more available properties 602 for display in a panel 604 of the user interface 600 when a corresponding hyperlink button 606 is actuated by the broker. Each entry of the available properties 602 in the panel 604 may include the property number 608 assigned by the bid server to the respective property of the seller, the zip code of the property 510, the price or price range 514 of the property, and the type of property 512.

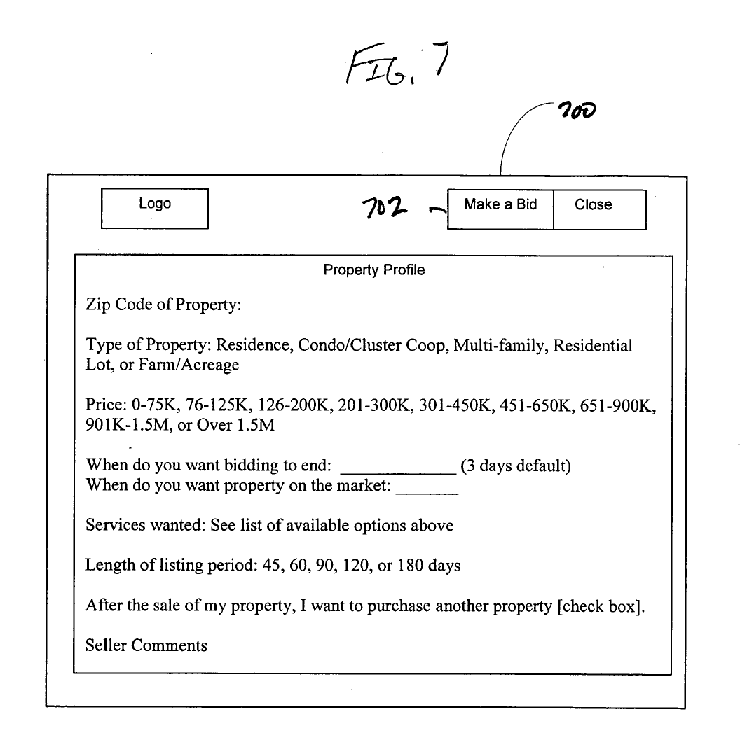

In one implementation, each property number 608 displayed in the panel 604 is a hyperlink to the respective property profile page 142a-142n. A broker interested in a property may select a displayed property number 608 hyperlink to cause the bid server 128 to provide the respective profile page 142a-142n to the broker's computer 106a-106n. FIG. 7 depicts an exemplary user interface 700 corresponding to the property profile page 142a, which the bid server 128 may provide in response to the selection of the property number 608 hyperlink.

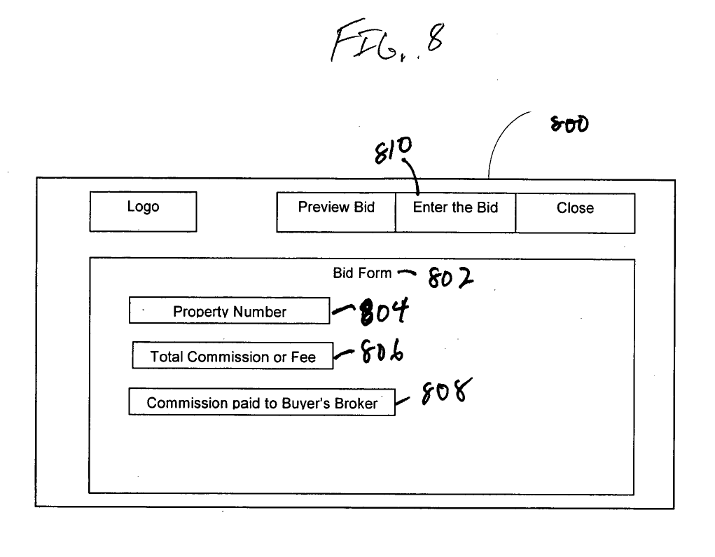

Returning to FIG. 4B, the bid server 128 next determines whether a bid has been received to list the property (Step 422). In one implementation, a broker requests to bid to list a property by actuating the “Make a Bid” button 702, which may be implemented as a hyperlink to cause the bid server 128 to provide the make bid page 144 to the respective broker computer 106m-106z. FIG. 8 depicts an exemplary user interface 800 corresponding to the bid page 144 that the bid server 128 provide for display on the broker computer 106m-106z in response to the broker's selection of the “Make a Bid” button 702. The user interface 800 includes a bid form 802 that includes a property number field 804 that has the property number 608 assigned by the bid server 128 to identify the property of the seller. In one embodiment, the bid server 128 prevents the property number field 804 from being edited by the broker. The bid form 802 also includes a commission or fee field 806 where the broker may identify to the bid server 128 the total commission rate or fee that the broker desires for selling the property. In addition, the bid form 802 may also include a commission paid to buyer's broker field 808 where the broker may identify to the bid server 128 the commission that will be paid to a Buyer's Broker (if any) when the sale of the property is closed. In one implementation, the broker submits the bid form 802 to the bid server 128 by actuating the “Enter the Bid” button 810.

If a bid has not been received, the bid server 128 determines whether time for bidding to list the property has elapsed (Step 424). In one implementation, the bid server may compare the current date kept by the server computer system 102 with the date for bidding to end 516 provided by the seller of the property to determine whether time for bidding to list the property has elapsed. If time for bidding to list the property has not elapsed, the bid server 128 continues processing at step 420 so that any recently registered brokers are provided with the property public profile based on the listing information of the property. If time for bidding to list the property has elapsed, the bid server 128 removes the property from bidding (Step 426) and ends processing for soliciting bids to list the property. In one implementation, the bid server 128 removes the property from bidding by deleting the property number from the database 124 such that the property number does not appear in the available properties page 140 generated by the bid server 128.

If a bid has been received, the bid server 128 provides the received bid to the seller of the property (Step 428). In one implementation, the bid server 128 provides the received bid to the seller by incorporating the received bid into a respective seller's bids page 134a-134n for the seller to access from the seller computer 104a-104n. For example, FIG. 9 depicts an exemplary user interface 900 corresponding to seller's bids page 134a that is provided by the bid server 128 to the respective seller computer 104m-104z after the seller has logged in or registered a property with the bid server 128 as discussed herein. In this implementation, the seller may cause the bid server 128 to provide a list of bids 902 submitted by one or more brokers for display in a panel 904 of the user interface 900 when a corresponding hyperlink button 906 is actuated by the seller. Each entry in the list of bids 902 may include a bid number 908 and a broker or bidder number 910. The bid number 908 is assigned to the bid by the bid server 128 in order to track the bid in relation to the bidder number (e.g., the broker that submitted the bid). Each entry in the list of bids 902 may also include a property number field 912 that has the property number 608 assigned to the property, the commission or fee 806 submitted by the broker, and the commission paid to buyer's broker 808 as submitted by the broker. Each entry in the list of bids 902 may also include a status field 912 and a contact option or field 914. The seller may select the contact option by entering a character into the contact field 914 to identify to the bid server 128 that the seller's contact information 526 is to be sent to the broker that submitted the bid. The status field 912 identifies whether the seller's contact information has already been sent by the bid server 128 to the broker who submitted the bid. In the implementation shown in FIG. 9, the seller actuates the “Have Selected Brokers Contact Me” button to cause the bid server 128 to submit the seller's contact information 526 to each broker associated with a bid that has an entry in the contact field 914.

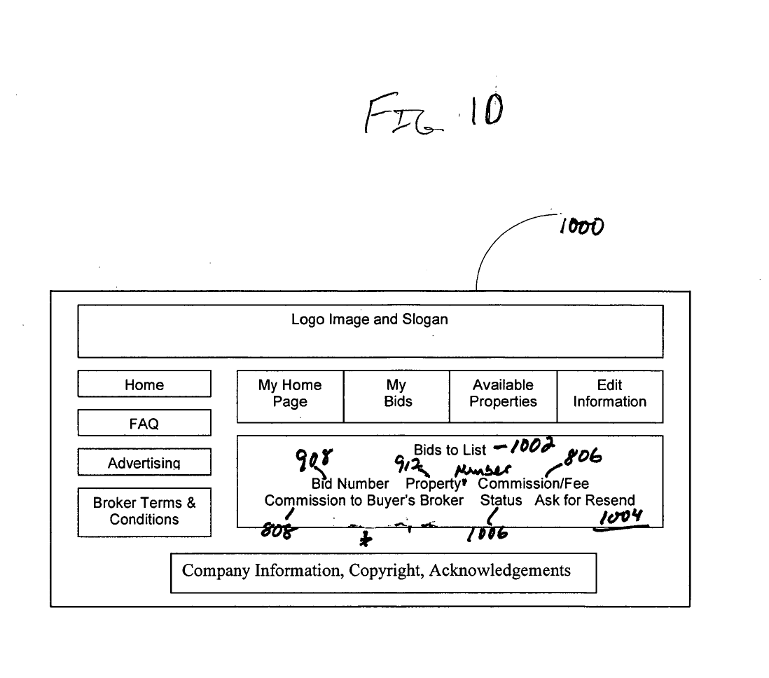

In one implementation, the bid server 128 also allows each broker to access the respective broker's bids page 138m-138z to view the status of any bids submitted by the broker. For example, FIG. 10 depicts an exemplary user interface 1000 corresponding to broker's bids page 138a that is provided by the bid server 128 to the respective seller computer 104m-104z in response to the broker selecting the “My Bids” button 610 on the user interface 600 in FIG. 6. The user interface 1000 includes an array of “bids to list” 1002 provided by the bid server 128 for display in a panel 1004 of the user interface 1000. Each entry or row in the “bids to list” array 1002 may include the bid number 908, the property number field 912, the commission or fee 806 submitted by the broker, the commission paid to buyer's broker 808 as submitted by the broker, and a bid status field 1006. The bid status field 1006 indicates whether the seller has requested the broker to contact the seller.

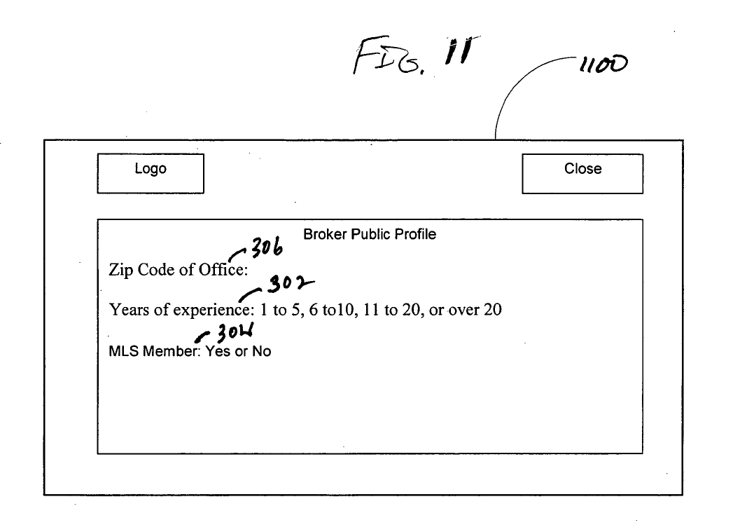

Continuing with FIG. 4B, after providing the received bid to the broker, the bid server 128 then determines whether a request has been received to view the profile of the broker that submitted the bid (Step 430). If a request to view the profile of the broker has been received, the bid server 128 provides the broker profile to the seller of the property (Step 432). In one implementation, the broker or bidder number 910 of the user interface 900 is implemented as a hyperlink. In this implementation, the bidder number 910 hyperlink may be selected by the seller to cause the bid server 128 to provide another user interface 1100 in FIG. 11 that includes the respective profile 136m-136z of the broker associated with the bidder number 910. If a request to view the profile of the broker has not been received, the bid server 128 continues processing at step 432.

Next, the bid server 128 determines whether seller wants to be contacted by the broker that submitted the bid (Step 434). As discussed above, the seller may specify to the bid server 128 to provide the seller's contact information 526 to a broker when the contact field 914 associated with bid number 908 is selected or filled. If it is determined that the seller wants to be contacted, the bid server 128 provides the seller's contact information to the broker that submitted the bid (Step 436).

If the seller does not want to be contacted or after providing the seller's contact information, the bid server 128 may also determine whether the bid has been accepted (Step 438). In one implementation, the bid status 912 of the user interface 900 is implemented as a hyperlink. In this implementation, the bid status 912 hyperlink may be selected by the seller to indicate to the bid server 128 that the respective bid has been accepted. Formal acceptance of a contract between the seller and the respective broker may take place before or after the seller identifies that the broker's bid has been accepted. If the bid has not been accepted, the bid server 128 continues processing at step 420 so that other recently registered brokers may also be provided with the listing information of the property. If the bid has been accepted, the bid server 128 alerts brokers that the property is no longer available for bidding (Step 440) before ending processing. In one implementation, the bid server 128 may alert brokers that the property is no longer available by sending a message to the e-mail address 318 of each broker that submitted a bid for the property. In another implementation, the bid server 128 may remove the respective property number 606 from the available properties page 144 so that the property is no longer available for bidding or posted in the broker's bids page 138m-138z.

The foregoing description of an implementation of the invention has been presented for purposes of illustration and description. It is not exhaustive and does not limit the invention to the precise form disclosed. Modifications and variations are possible in light of the above teachings or may be acquired from practicing of the invention. Additionally, the described implementation includes software, such as the bid server, but the present invention may be implemented as a combination of hardware and software or in hardware alone. Note also that the implementation may vary between systems. The invention may be implemented with both object-oriented and non-object-oriented programming systems. The claims and their equivalents define the scope of the invention.

What is claimed is:

1. A method in a data processing system for soliciting a bid to list a property, the method comprising:
receiving from a seller a request to list a property for sale;
receiving information for listing the property;
providing the listing information to one or more brokers;
receiving one or more bids to list the property from each of the one or more brokers based on the listing information; and
providing the one or more bids to the seller.

2. A method of claim 1, wherein the listing information includes a zip code for the property.

3. A method of claim 2, further comprising receiving a geographic area associated with the one or more brokers, wherein the step of providing the listing information comprises providing the listing information to the one or more brokers when the zip code for the property is in the geographic area.

4. A method of claim 2, further comprising receiving a zip code for bidding from a first of the one or more brokers, wherein the step of providing the listing information comprises providing the listing information to the first broker when the zip code for the property corresponds to the zip code for bidding.

5. A method of claim 1, wherein the listing information further includes a period duration for listing the property;

6. A method of claim 1, wherein the listing information further includes a service to be performed in accordance with listing the property;

7. A method of claim 1, wherein the listing information further includes an asking price for the property;

8. A method of claim 1, further comprising associating a property number with the listing information, wherein the step of providing the listing information further comprises providing the property number with the listing information to the one or more brokers without identifying the seller.

9. A method of claim 1, further comprising assigning a bidder number to a first of the one or more brokers, wherein the step of providing the one or more bids further comprises providing each of the bids received from the first broker with the bidder number assigned to the first broker without identifying the first broker.

10. A method of claim 1, further comprising:
receiving contact information for the seller;
associating a contact option with each of the bids provided to the seller; and
providing the seller's contact information to a first of the one or more brokers in response to a selection by the seller of the contact option associated with a first of the bids received from the first broker.

11. A data processing system, comprising:
a seller computer operatively connected to a network;
a plurality of broker computers operatively connected to the network;
means for receiving, via the seller computer, a request to list a property for sale;
means for receiving, via the seller computer, information for listing the property;
means for providing the listing information to a plurality of brokers each operating on a respective one of the broker computers;
means for receiving one or more bids to list the property from each of the plurality of brokers based on the listing information; and
means for providing the one or more bids to the seller computer.

12. A data processing system of claim 11, wherein the listing information includes a zip code for the property.

13. A data processing system of claim 12, further comprising means for receiving a geographic area associated with the one or more brokers, wherein the means for providing the listing information further comprises means for providing the listing information to the one or more brokers when the zip code for the property is in the geographic area.

14. A data processing system of claim 12, further comprising means for receiving a zip code for bidding from a first of the one or more brokers, wherein the means for providing the listing information further comprises means for providing the listing information to the first broker when the zip code for the property corresponds to the zip code for bidding.

15. A data processing system of claim 11, further comprising means for associating a property number with the listing information, wherein the means for providing the listing information further comprises means for providing the property number with the listing information to the one or more brokers without identifying the seller.

16. A data processing system of claim 11, further comprising means for assigning a bidder number to a first of the one or more brokers, wherein the means for providing the one or more bids further comprises means for providing each of the bids received from the first broker with the bidder number assigned to the first broker without identifying the first broker.

17. A data processing system of claim 11, further comprising:
means for receiving contact information for the seller;
means for associating a contact option with each of the bids provided to the seller; and
means for providing the seller's contact information to a first of the one or more brokers in response to a selection by the seller of the contact option associated with a first of the bids received from the first broker.

18. A data processing system, comprising:
a seller computer operatively connected to a network;
a plurality of broker computers operatively connected to the network;
a memory having a bid server program operatively connected, via the network, to the seller computer and to the broker computers, the bid server program receives from a seller operating on the seller computer a request to list a property, receives information for listing the property, provides the listing information to a plurality of brokers operating on the broker computers, receives one or more bids to list the property from each of the one or more brokers based on the listing information, and provides the one or more bids to the seller; and
a processor to run the bid server program.

19. A data processing system of claim 18, wherein the listing information includes a zip code for the property.

20. A data processing system of claim 19, wherein the bid server program is further configured to receive a geographic area associated with the one or more brokers and to provide the listing information to the one or more brokers when the zip code for the property is in the geographic area.

21. A data processing system of claim 19, wherein the bid server program is further configured to receive a zip code for bidding from a first of the one or more brokers, and to provide the listing information to the first broker when the zip code for the property corresponds to the zip code for bidding.

22. A data processing system of claim 18, wherein the bid server program is further configured to associate a property number with the listing information, and to provide the property number with the listing information to the one or more brokers without identifying the seller.

23. A data processing system of claim 18, wherein the bid server program is further configured to assign a bidder number to a first of the one or more brokers, and to provide each of the bids received from the first broker with the bidder number assigned to the first broker without identifying the first broker.

24. A data processing system of claim 18, wherein the bid server program is further configured to receive contact information for the seller; to associate a contact option with each of the bids provided to the seller; and to provide the seller's contact information to a first of the one or more brokers in response to a selection by the seller of the contact option associated with a first of the bids received from the first broker.

25. A computer-readable medium containing instructions that cause a data processing system having a bid server program to perform a method for soliciting a bid to list a property, the method comprising:
receiving from a seller a request to list a property for sale;
receiving information for listing the property;
providing the listing information to one or more brokers;
receiving one or more bids to list the property from each of the one or more brokers based on the listing information; and
providing the one or more bids to the seller.

26. A computer-readable medium of claim 25, wherein the listing information includes a zip code for the property.

27. A computer-readable medium of claim 26, the method further comprising receiving a geographic area associated with the one or more brokers, wherein the step of providing the listing information comprises providing the listing information to the one or more brokers when the zip code for the property is in the geographic area.

28. A computer-readable medium of claim 26, the method further comprising receiving a zip code for bidding from a first of the one or more brokers, wherein the step of providing the listing information comprises providing the listing information to the first broker when the zip code for the property corresponds to the zip code for bidding.

29. A computer-readable medium of claim 25, the method further comprising associating a property number with the listing information, wherein the step of providing the listing information further comprises providing the property number with the listing information to the one or more brokers without identifying the seller.

30. A computer-readable medium of claim 25, the method further comprising assigning a bidder number to a first of the one or more brokers, wherein the step of providing the one or more bids further comprises providing each of the bids received from the first broker with the bidder number assigned to the first broker without identifying the first broker.

31. A computer-readable medium of claim 25, the method further comprising:
receiving contact information for the seller;
associating a contact option with each of the bids provided to the seller; and
providing the seller's contact information to a first of the one or more brokers in response to a selection by the seller of the contact option associated with a first of the bids received from the first broker.
